(19) United States
(12) Patent Application Publication
(10) Pub. No.: US 2023/0288787 A1
(43) Pub. Date: Sep. 14, 2023

(54) Arrangement And A Modular Construction System For Load-Bearing Mounting Of A Function Module

(71) Applicant: Volucap GmbH, Potsdam (DE)

(72) Inventor: Sven BLIEDUNG VON DER HEIDE, Potsdam (DE)

(73) Assignee: Volucap GmbH, Potsdam (DE)

(21) Appl. No.: 18/179,851

(22) Filed: Mar. 7, 2023

(30) Foreign Application Priority Data
Mar. 9, 2022 (DE) 102022105507.8

(51) Int. Cl. G03B 17/56

(52) U.S. Cl. CPC G03B 17/561

(57) ABSTRACT

An arrangement is provided for supportingly accommodating a functional module, comprising: a modular support structure which is formed with support elements which are designed with a hollow cross-section and profile elements lying opposite one another, wherein the profile elements each have a middle half-tube portion and partial wing portions integrally formed thereon on both sides with profile element openings, and the partial wing portions of the profile elements are arranged flat on top of one another in such a way that the profile element openings are assigned to one another in pairs, the half-tube portions of each of the carrier elements form a tube portion, and the partial wing portions of each of the carrier elements each form a wing portion, and a functional module which is mounted on the support structure. Furthermore, a modular system is provided.

The invention relates to an arrangement and a modular system for an arrangement for supportingly accommodating a functional module.

### BACKGROUND

In the provision of structures for fastening, for example, multi-camera systems, either parts and profile shapes are regularly used from prefabricated exhibition stand systems, or an individually adapted structure is built for each specific use and can be employed effectively only for this use.

However, prefabricated exhibition stand systems have the disadvantage that they are primarily designed for walls and non-movable installations. Consequently, flexible or movable use is only possible in this way to a very limited extent. Furthermore, such prefabricated systems offer few possibilities to erect specific scaffold shapes.

Although individually adapted structures in principle enable more precisely adapted superstructures, they are even less flexible with regard to subsequent adaptations than prefabricated systems because they are designed for specific application scenarios.

Furthermore, guiding, for example, electrical lines when attaching lighting devices to wall systems is regularly insufficiently taken into account. In known systems, retrofitting is often difficult to accomplish due to the lack of flexibility. The work required for this can represent an additional burden during the work-intensive preparation phase and repeatedly changing demands of film production.

### SUMMARY

The object of the invention is to specify an arrangement and a modular system with which functional modules can be flexibly accommodated in a load-bearing manner.

An arrangement and a modular system for an arrangement for supportingly accommodating a functional module according to the independent claims are provided for the solution. Embodiments are the subject matter of dependent claims.

According to one aspect, an arrangement for supportingly accommodating a functional module is provided. The arrangement comprises: a modular support structure which is formed with carrier elements which are provided (designed) with a hollow cross-section and profile elements lying opposite one another, wherein the profile elements each have a middle half-tube portion and partial wing portions integrally formed thereon on both sides with profile element openings, and the partial wing portions of the profile elements are arranged flat on top of one another in such a way that the profile element openings are assigned to one another in pairs, the half-tube portions of each of the carrier elements form a tube portion, and the partial wing portions of each of the carrier elements each form a wing portion, and a functional module which is mounted on the support structure.

According to a further aspect, a modular system for an arrangement for supportingly accommodating a functional module is provided, having carrier elements for a modular support structure, wherein the carrier elements are provided (designed) with a hollow cross-section and profile elements lying opposite one another, wherein the profile elements each have a middle half-tube portion and partial wing portions integrally formed thereon on both sides with profile element openings, and the partial wing portions of the profile elements are arranged flat on top of one another in such a way that the profile element openings are assigned to one another in pairs, the half-tube portions of each of the carrier elements each form a tube portion, and the partial wing portions of each of the carrier elements form a wing portion.

In this way, efficient supporting accommodation or fastening of (functional) modules for image and/or sound recording production, for example, can be made possible with low weight and at the same time high stability, design flexibility, and simplified and accelerated assembly and disassembly of the arrangement. Particularly in the case of multi-camera systems, volumetric recordings and light field recordings, such modules can be arranged in a flexible manner, for instance spherically. Positioning of the individual modules can be made possible in small units and at variable distances, which can be more difficult in particular with finished exhibition stand construction systems given distances that are regularly too large and uniform. Furthermore, straight surfaces and spherical fastening points can be flexibly defined in space. Individual but also reusable structures can therefore be realized.

For this purpose, in particular the profile shape of the carrier elements and the correspondingly designed joints and mounting elements can enable a stable and at the same time easily adaptable assembly of the arrangement. Further structural complexity, for example in the case of heavier devices, for example movie cameras or media transmission devices, can be avoided.

Profile element openings assigned to each other can together form an opening in one of the wing portions. The opening (hole, through-opening) and/or the profile element openings can each be circular. The opening and/or the profile element openings can each be a bore. Each of the wing portions can have, for example, between 2 and 100 openings, preferably between 20 and 60 openings, particularly preferably between 30 and 50 openings.

The wing portions can each extend in the longitudinal direction of the tube portion and be substantially planar.

First openings of a first of the two wing portions can be arranged in a manner aligned with one another in pairs with second openings of the second of the two wing portions along a transverse direction.

The openings of the two wing portions can each be arranged in a row along the longitudinal direction. In particular, the first openings can be arranged in a first row along the longitudinal direction, and/or the second openings can be arranged in a second row along the longitudinal direction. The openings, in particular the first openings and the second openings, can each be arranged equidistantly to one another, for example with an opening distance between 3 cm and 20 cm. First and second openings that are aligned in pairs with one another can each be at a distance between 5 cm and 25 cm.

The openings can have the same opening diameter, for example between 5 mm and 50 mm. Alternatively, different opening diameters can be provided, for example, openings of a larger diameter between 20 mm and 50 mm and openings of a smaller diameter between 5 mm and 25 mm alternating for each of the wing portions.

The carrier element, in particular the tube portion and/or at least one of the two wing portions, can also have at least one of a thread, depression, groove, bead, grain and relief cut. In particular, each of the openings can have an opening thread. At least one wing bead can be formed in each of the wing portions, for example in the longitudinal direction or in the transverse direction of the carrier element.

The tube portion can have a substantially round or oval cross-section (profile), for example an O-profile. The wing portions can preferably extend radially from the tube portion.

Alternatively, the tube portion can also have a polygonal cross-section, in particular approximately a square cross-section, a hexagonal portion or an octagonal portion. In this case, the wing portions can likewise extend laterally outwards from the tube portion with respect to a tube portion cross-section center.

Each of the wing portions can extend (substantially) along a plane (wing portion plane). In particular, each of the wing portions can have a flat region. Each of the wing portions can be substantially plate-shaped.

The carrier element can be mirror-symmetrical, in particular with respect to the wing portion plane and/or with respect to a plane orthogonal to the wing portion plane. Specifically, a profile of the carrier element can be mirror-symmetrical, in particular with respect to a straight line along which a profile of the wing portions extends, and/or with respect to a straight line orthogonal thereto.

The flat region can be arranged substantially perpendicular to a circumferential direction of the tube portion.

The tube portion can be curved towards at least one of the wing portions. In particular, the cross-section of the tube portion can have at least one, preferably two inflection points, which separate a first region of the tube portion with a circular curvature from a second region to a curvature of the flat portion.

Each of the half-tube portions can have substantially a semicircular cross-section or half-oval cross-section. Each of the half-tube portions can have substantially a U-profile.

The partial wing portions can each be arranged in alignment with one another and/or be non-releasably connected to one another. Each of the partial wing portions can extend substantially along a plane. In particular, each of the partial wing portions can have a flat region. Each of the partial wing portions can be substantially plate-shaped. Each of the half-tube portions can each be curved towards at least one of the partial wing portions. In particular, the respective cross-section of the half-tube portions can have at least one, preferably two, inflection points which separate a first region of the half-tube portion with a (semi-)circular curvature from a second region to a curvature of the flat partial wing portion.

In each case, at least one opening of the wing portions can extend through both partial wing portions.

The half-tube portions can be non-releasably connected, for example glued, to one another. Alternatively, the half-tube portions can also be releasably connected to one another. The half-tube portions can in particular be connected to one another by means of the partial wing portions.

The partial wing portions arranged in alignment with one another can be non-releasably connected, for example glued, to one another. Alternatively, the partial wing portions arranged in alignment with one another can be releasably connected to one another, for example by means of a partial wing fastening means through one of the openings.

The partial wing portions can be connected to each other along the flat regions. In particular, first partial wing portions of a first of the profile elements can be arranged in a form-fitting manner with second partial wing portions of a second of the profile elements.

The wing portions and/or the partial wing portions can be formed continuously in the longitudinal direction. The profile elements, in particular the partial wing portions and/or the half-tube portions can be formed free of inner edges/kinks.

The half-tube portions of each of the profile elements can each be arranged in a common plane.

The tube portion can have a constant tube portion thickness, and/or the wing portions can each have a constant wing portion thickness. The profile elements can each have a constant profile element thickness which is preferably equal to the tube portion thickness and/or a partial wing portion thickness. The tube portion thickness can be half the wing portion thickness.

It can also be provided that the carrier element has a constant thickness. In particular, the tube portion thickness can be equal to the wing portion thickness and/or equal to twice the partial wing portion thickness. The profile elements can be tapered in the lateral direction.

The tube portion thickness and/or the partial wing portion thickness can be, for example, between 0.5 mm and 25 mm. The wing portion thickness can be, for example, between 1 mm and 50 mm.

The wing portions can each have a wing portion width between 25% and 100% of a tube portion width. The wing portions can preferably each have a length between 40% and 60% of the tube portion width in the lateral direction.

The wing portion thickness can be less than 20%, preferably less than 10% of the wing portion width. The tube portion thickness can be less than 10%, preferably less than 5% of the tube portion width.

The tube portion width can be, for example, between 1 cm and 25 cm. In the case of a round cross-section of the tube portion, the tube portion width can be equal to a tube portion diameter. The wing portion width can be, for example, between 1 cm and 15 cm.

The functional module can be a functional module from the following group: film production module, image recording module, sound recording module, lighting module and measuring modules for depth information, movement data and material properties. These include, for example, (RGB, IR, time of flight) cameras, (directional) microphones, lighting means such as spotlights and LEDs, as well as radar and laser scanning technology. The lighting devices can have, for example, a total illuminance of 1000 lux to 50,000 lux, preferably of 5000 lux to 15,000 lux.

The functional module can have, for example, a weight of about 0.1 kg to about 20 kg, preferably up to about 10 kg, more preferably up to about 5 kg.

The tube portion can have a tube portion length of 20 cm to 200 cm. The wing portions can also have a wing portion length of 20 cm to 200 cm.

The tube portion length can be equal to the wing portion length. Alternatively, the tube portion length can be longer or shorter than the wing portion length, in particular by more than 5% of the tube portion length. The tube portion can, for example, project beyond the wing portions in the longitudinal direction.

The arrangement and/or the carrier elements can also comprise carbon fibers. The arrangement and/or the carrier elements can in particular comprise carbon-fiber reinforced plastic (CFRP). The carrier element and/or the profile elements can especially be formed substantially from or consist of carbon fibers or CFRP. In this way, easier transport and setup can be made possible, in particular in relation to the use of iron or aluminum, for instance, which can cause a high dead weight.

Further fastening means, in particular the partial wing fastening means, can have a metal (for example, steel) or be formed from the metal. By using metals only at necessary locations (for example, for screw connections), the stability of metal can be combined with the lightness of carbon fibers.

The support structure can have a joint with joint elements which are connected to one another and rotatable with respect to one another, each of which is formed with a joint holder which is configured to retain a first of the carrier elements therein.

The joint holder of each joint element can be configured to accommodate a carrier element in a form-fitting manner in the longitudinal direction. The joint holder can have a first and a second groove which are preferably configured to accommodate in each case one of the wing portions in a form-fitting manner in the longitudinal direction. The joint holder can have a cylinder element which is preferably configured to accommodate the tube portion in a form-fitting manner in the longitudinal direction. The first groove and the second groove can be arranged opposite with respect to the joint holder.

Each joint element can have two partial joint elements, the joining of which forms the joint holder and preferably the first groove and the second groove. The partial joint elements can be non-releasably connected to one another (for example, glued or riveted). The joint elements can be arranged on a axis and can be rotatable relative to one another by means of the shaft.

The joint can have a locking means. The locking means can be configured to releasably lock a longitudinal movement of the first of the carrier elements (in the joint element).

Each joint element can have at least one locking opening which preferably intersects the first groove or the second groove. The at least one locking opening can be arranged in such a way that it is aligned with one of the openings in the wing portion (when the carrier element is displaced in a certain way) when the first carrier element is accommodated.

The locking means can have at least one locking fastening means which is configured to releasably lock the carrier element by means of the locking opening and the opening in the wing portion. The carrier element can therefore be releasably connected to one of the joint elements by means of the locking fastening means through the opening and the locking opening.

The locking fastening means can have, for example, a screw connection and/or a latching connection.

Additionally or alternatively, the carrier element can also be locked by means of pressing of the partial joint elements by means of the locking means.

The joint can also have a rotational locking means which is configured to releasably lock a rotation of the joint elements relative to one another and/or to releasably fix an angle of rotation of the joint elements relative to one another. For example, the joint elements can each have at least one rotational locking opening, each of which is configured to align with one another when the joint elements are rotated to a certain angle of rotation. At least one of the joint elements can have, in particular, a plurality of rotational locking openings, each of which is configured to align with the at least one rotational locking opening of the other of the joint elements when the joint elements are rotated to certain angles of rotation. The rotational locking means can have at least one rotational locking fastening means which is configured to releasably lock the rotational movement of the joint elements relative to one another by means of the rotational locking openings of the joint elements.

The joint elements can have carbon fibers or CFRP. In particular, the joint elements can be formed substantially from carbon fibers or CFRP. The joint holder can have, for example, a length between 5 cm and 30 cm.

The support structure can have a mounting element with a mounting holder in which the first or a second of the support tube elements is arranged, and a connection element with which a support element and/or the functional module is accommodated, in particular mounted, on the support structure.

Additionally or alternatively to the accommodation of functional modules on connection elements on mounting elements, (additional) functional modules can also be accommodated at further points of the arrangement, for example on the head element and/or on the wing portions.

The mounting holder of the mounting element can have a third groove and a fourth groove which are preferably configured to each accommodate one of the wing portions in a form-fitting manner in the longitudinal direction. The mounting holder can have a second cylinder element which is preferably configured to accommodate the tube portion in a form-fitting manner in the longitudinal direction. The third groove and the fourth groove can be arranged opposite with respect to the mounting holder.

The mounting element can have two partial mounting elements, the joining of which forms the mounting holder and preferably the third groove and the fourth groove. The partial mounting elements can be non-releasably connected to one another (for example, glued or riveted).

The mounting element can have a second locking means. The second locking means can be configured to releasably lock (in the mounting element) a longitudinal movement of the carrier element accommodated in the mounting element. The mounting element can have at least one mount locking opening which preferably intersects the third groove or the fourth groove. The at least one mount locking opening can be arranged in such a way that it is aligned with one of the (further) openings of the wing portion (when the carrier element is displaced in a certain way) when the carrier element is accommodated. The second locking means can have at least one second locking fastening means which is configured to releasably lock the carrier element by means of the mount locking opening and the opening in the wing portion. The second locking fastening means can have a screw connection and/or a latching connection. Additionally or alternatively, the carrier element can also be locked using the second locking means by pressing the partial mounting elements.

The connection element of the mounting element can, for example, be tubular. The connection element can be arranged substantially perpendicular to the longitudinal direction of the mounting holder. The connection element can also have, for example, an assembly socket.

The mounting element can have carbon fibers or CFRP. In particular, the mounting element can be formed substantially from carbon fibers or CFRP. The mounting holder can have, for example, a length between 5 cm and 30 cm.

Each of the carrier elements can be arranged in the arrangement in a manner that cannot be displaced and/or in a rotationally fixed manner, in particular by means of respective locking means or rotational locking means of the plurality of joints.

The arrangement can have a head element which is configured to be releasably connectable to several of the plurality of carrier elements. Preferably, a first carrier element group can be connected releasably in series with one another to form a first arm by means of a first joint group, and/or a second carrier element group can be connected releasably in series with one another to form a second arm by means of a second joint group, and/or a third carrier element group can be connected releasably in series with one another to form a third arm by means of a third joint group of the plurality of joints. The first arm, and/or the second arm, and/or the third arm can each be releasably fastened to the head element at a first arm end. In addition, other correspondingly formed arms can be provided. The first arm, and/or the second arm, and/or the third arm can also each be arranged on a base or ground at a second arm end, in particular by means of respective foot elements (floor modules). The foot elements can, for example, each be disk-shaped.

The head element can be configured such that carrier elements connected to the head element extend in a ray-shaped manner from a head element center. For this purpose, the head element can have a plurality of head connection elements which extend in a ray-shaped manner from the head element center. The head connection elements can each be spaced apart from one another at an equal angle. Alternatively, the head connection elements can each have different distances from one another.

The head connection elements can be arranged in one plane. The head element can be rotationally symmetrical. Alternatively, the head element can also have, for example, a strip shape.

The head element can have a plurality of head fastening means, each of which is configured for releasable connection to one of the carrier elements. In particular, each of the head fastening means can comprise a rail element that is releasably fastened to one of the head connection elements and one of the carrier element and is preferably aligned with them.

The head element can have, for example, 3 to 20 head connection elements. The arrangement can accordingly have 3 to 20 arms. Each arm can have, for example, 3 to 10 carrier elements. It can be provided that each arm has the same number of carrier elements.

It can be provided that each of the arms is formed with a substantially quarter-circle shape by means of the joints of the arm. The arrangement can accordingly substantially have a hood shape or a barrel vault shape (for example, for a walkway).

It can also be provided that each of the arms is formed in a straight line by means of the joints of the arm. The arrangement can accordingly have substantially a conical shape, a pyramid shape or a prism shape.

Furthermore, it can be provided that each of the arms is formed at an angle, preferably a right angle (L shape), by means of the joints of the arm. The arrangement can accordingly have substantially a cylindrical shape or a cuboid shape.

The arrangement can further comprise a plurality of mounting elements and a first support element, wherein preferably a first mounting element of the plurality of mounting elements can be fastened on one of the carrier elements of the first arm and a second mounting element on one of the carrier elements of the second arm and, particularly preferably, the first mounting element can be releasably connected to the second mounting element via the first support element. In particular, the first arm and the second arm can be adjacent.

In the context of the disclosure, two elements are adjacent when no identical element is arranged between the two elements.

Furthermore, a third mounting element on one of the carrier elements of the first arm, which is adjacent to the first mounting element of the first arm, can be releasably connected to a fourth mounting element on one of the carrier elements of the second arm, which is adjacent to the second mounting element of the second arm, via a second support element. In particular, the first and the third mounting elements can be arranged on the same carrier element, and/or the second and the fourth mounting elements can be arranged on the same carrier element. The first support element and the second support element can be arranged crosswise. Alternatively, the first support element and the second support element can be arranged substantially parallel to one another.

In general, adjacent arms can be connected to one another via a plurality of support elements, for example in the form of a framework. At least one or each of the support elements can be tubular. At least one or each of the support elements can tubular can have a tube or a plurality of tubes, for example two or three tubes. The support elements can have carbon fibers and/or CFRP. The support elements can consist substantially of carbon fibers or CFRP.

The arrangement can also have frames and/or frame elements (for instance, as one of a wall frame, floor frame, wall frame element and floor frame element), in particular for connecting carrier elements.

In the arrangement and/or in the support structure, an interior space can be formed which is preferably dimensioned to partially or completely surround a person and/or a plurality of persons (for example, one to ten persons) and/or a body part (for example, a person's head). The arrangement can be configured for fastening one to 80 cameras, preferably 12 to 40 cameras.

The arrangement can have a light-permeable layer which is preferably configured to partially or completely surround the interior space above the base (ground). The layer can preferably have a substantially white color.

The arrangement can be arranged movably or immovably (for example, fastened) on the base (ground).

The embodiments described above in connection with the arrangement can be provided accordingly for the modular system (kit).

### DESCRIPTION OF EXAMPLES OF EMBODIMENT

Further exemplary embodiments will be explained in more detail below with reference to figures of a drawing. In the drawing:

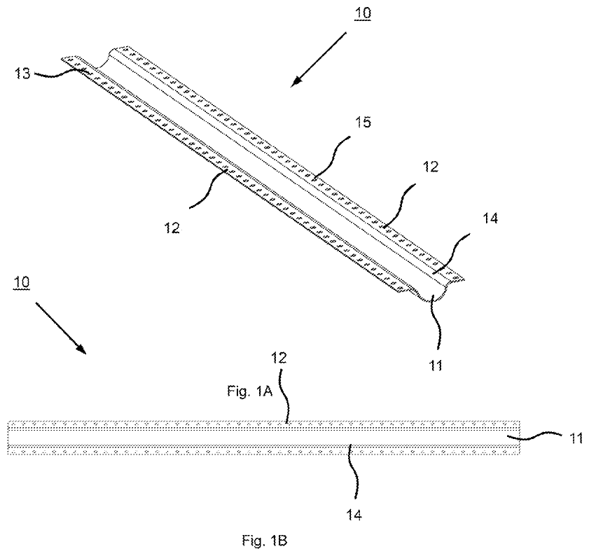

FIG. 1a shows a schematic illustration of a profile element in one view;

FIG. 1b shows a schematic illustration of the profile element in a plan view;

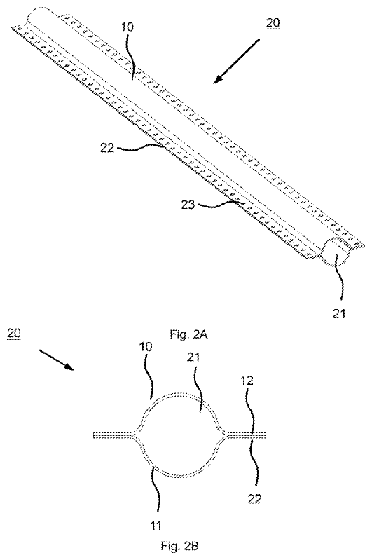

FIG. 2a shows a schematic illustration of a carrier element in a first view;

FIG. 2b shows a schematic illustration of the carrier element in a profile view;

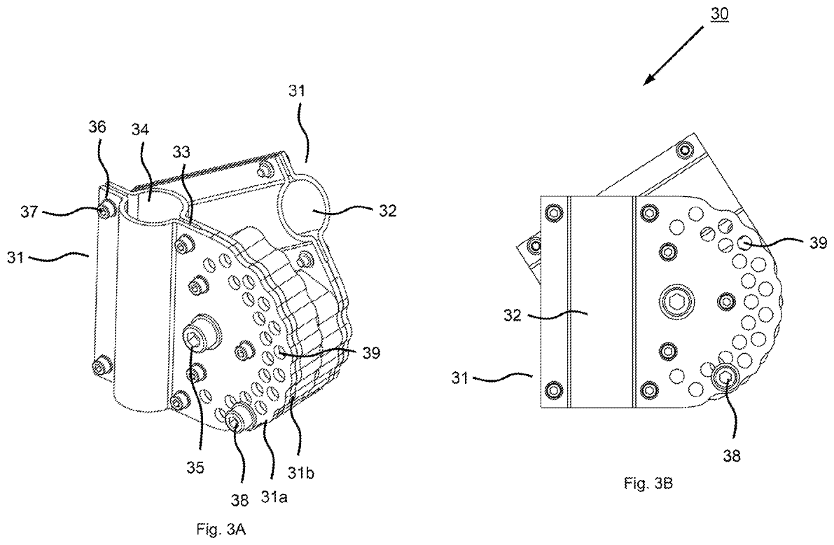

FIG. 3a shows a schematic illustration of a joint in a first view;

FIG. 3b shows a schematic illustration of the joint in a second view;

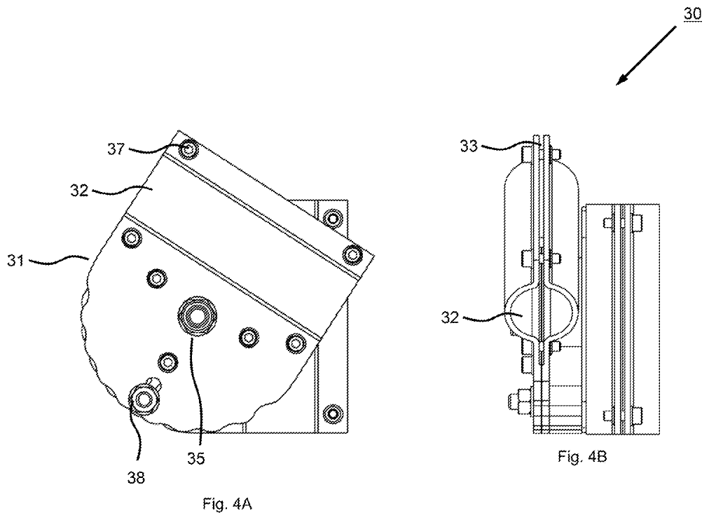

FIG. 4a shows a schematic illustration of the joint in a third view;

FIG. 4b shows a schematic illustration of the joint in a fourth view;

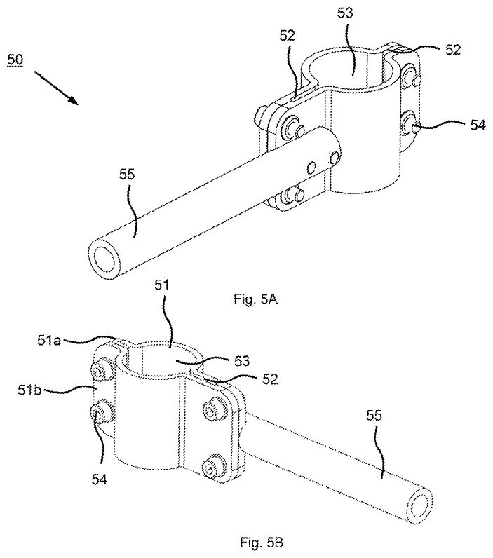

FIG. 5a shows a schematic illustration of a mounting element in a first view;

FIG. 5b shows a schematic illustration of the mounting element in a second view;

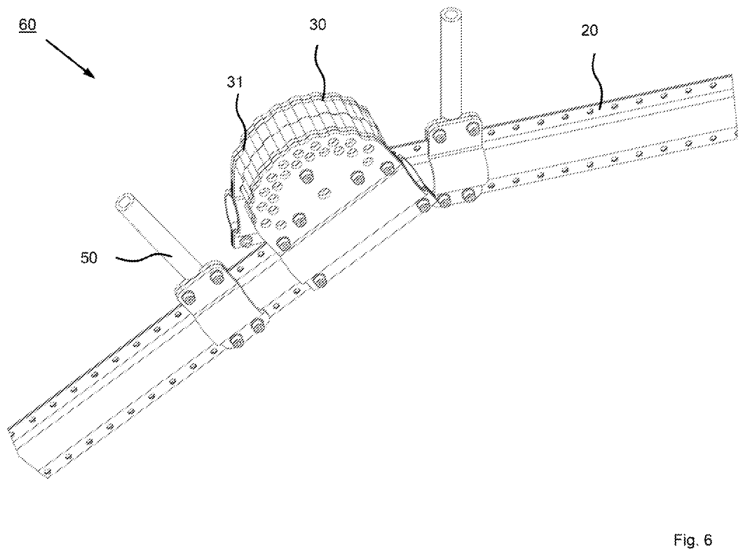

FIG. 6 shows a schematic illustration of a first partial arrangement with a joint and two carrier elements;

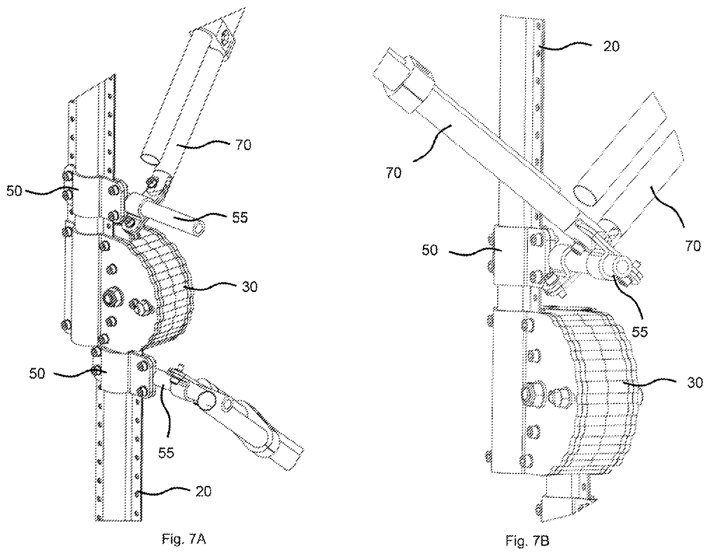

FIG. 7a shows a schematic illustration of a second partial arrangement with a joint, two carrier elements and two mounting elements;

FIG. 7b shows a schematic illustration of a third partial arrangement with a joint, two carrier elements and a mounting element;

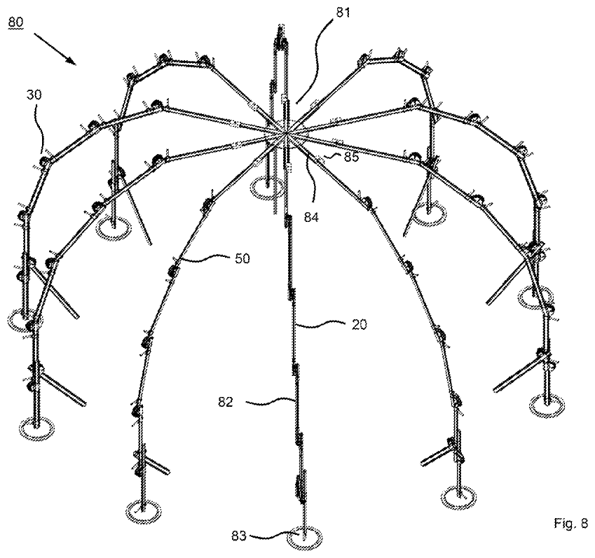

FIG. 8 shows a schematic illustration of a support structure in a first view;

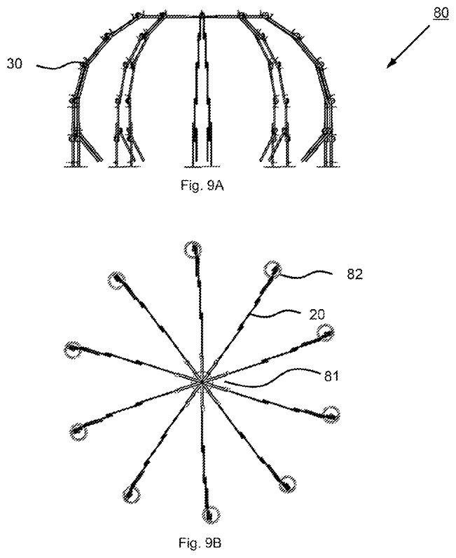

FIG. 9a shows a schematic illustration of the support structure in a second view;

FIG. 9b shows a schematic illustration of the support structure in a third view;

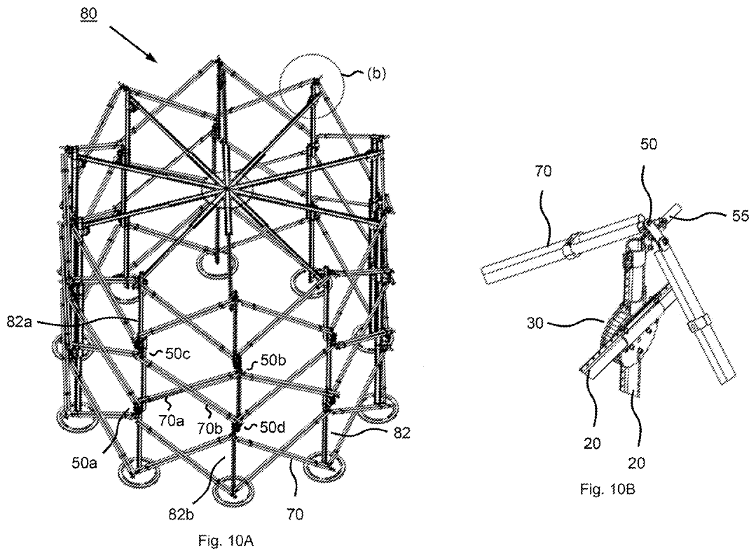

FIG. 10a shows a schematic illustration of a further embodiment of the support structure in a first view;

FIG. 10b shows a detailed view of the support structure;

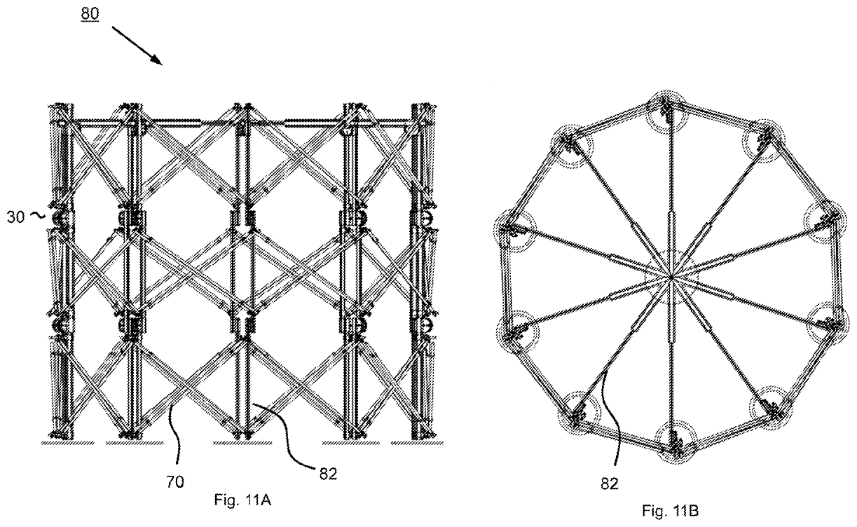

FIG. 11a shows a schematic illustration of the support structure in a second view, and

FIG. 11b shows a schematic illustration of the support structure in a third view;

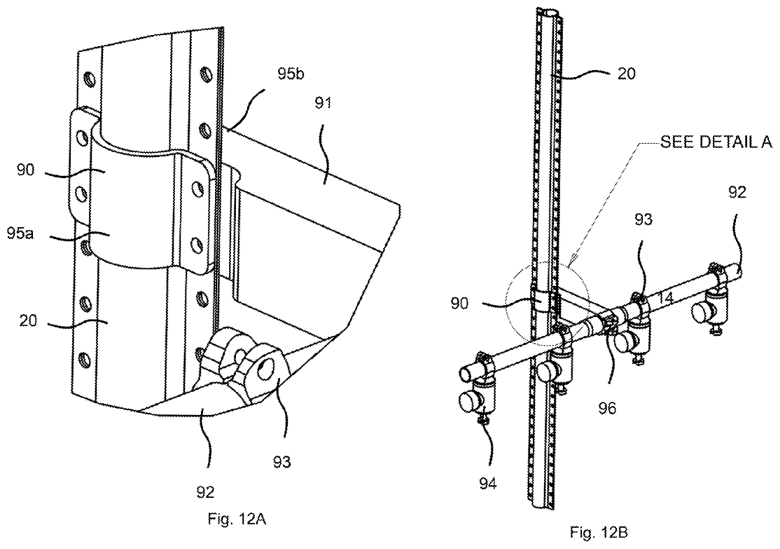

FIG. 12a shows a schematic perspective illustration of an arrangement with mounting elements;

FIG. 12b shows a schematic illustration for a detail A of the arrangement from FIG. 12a;

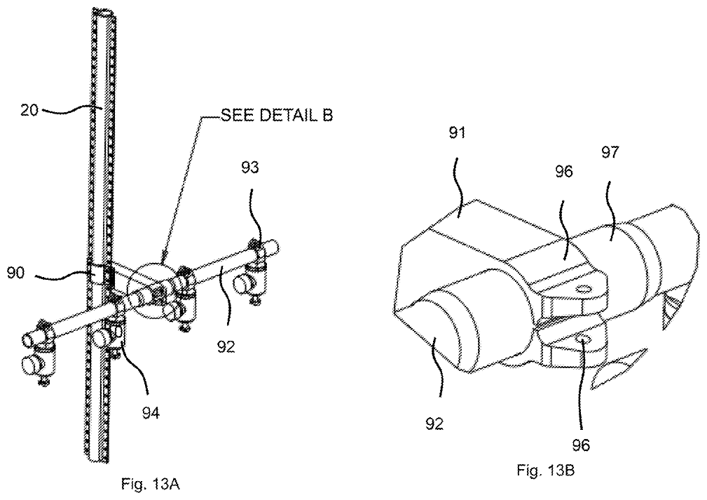

FIG. 13a shows another schematic perspective illustration of the arrangement with mounting elements from FIG. 12a;

FIG. 13b shows a schematic illustration for a detail B of the arrangement from FIG. 13a;

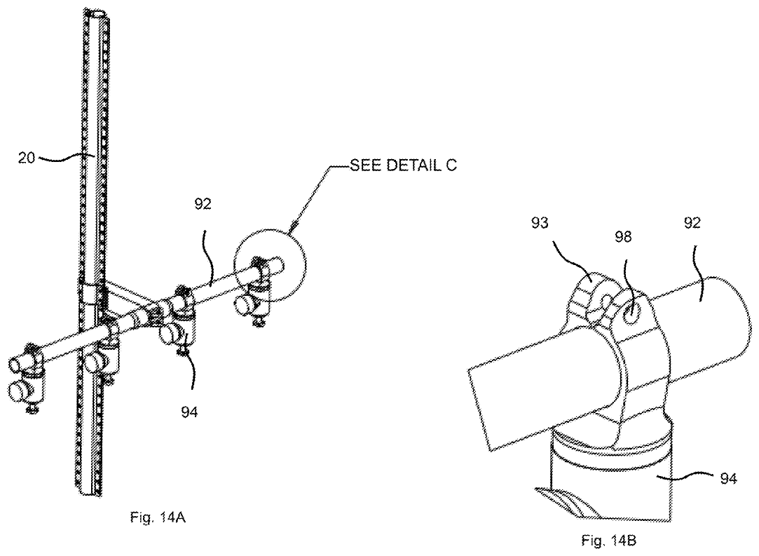

FIG. 14a shows another schematic perspective illustration of the arrangement with mounting elements from FIG. 12a; and

FIG. 14b shows a schematic illustration for a detail C of the arrangement from FIG. 14a.

FIG. 1a shows a schematic illustration of a profile element 10 in one view, and FIG. 1b shows a schematic illustration of the profile element 10 in a plan view. The profile element 10 has a half-tube portion 11 with a U-profile (in the transverse direction) and a first and second partial wing portion 12. Profile element openings 13 can be provided in each of the partial wing portions 12. Regions of changing curvature in the profile of the half-tube portion 11 are illustrated by means of the inflection point line 14. The partial wing portions 12 have a flat planar region 15.

FIG. 2a shows a schematic illustration of a carrier element 20 having a tube portion 21 and two wing portions 22 in a first view, and FIG. 2b shows a schematic illustration of the carrier element 20 in a profile view.

The carrier element 20 has two profile elements 10 which are connected to one another in the longitudinal direction, for example by gluing partial wing portions 12 that are in each case arranged in alignment with one another, in particular on the planar regions 15 which can be arranged on one another in a form-fitting manner. In this way, the partial wing portions 12 form the wing portions 22. The half-tube portions 11 together form the tube portion 21.

Openings 23 in the wing portions are formed from the profile element openings 13. The profile element openings 13 in one of the profile elements 10 are therefore arranged in pairs in alignment with further profile element openings 13 of the other of the profile elements 10. It can be provided that the openings 23 are produced after connecting the profile elements 10 or alternatively before connecting the profile elements 10.

FIGS. 3a and 3b show schematic illustrations of a joint 30 in a first view and a second view, respectively. Furthermore, FIG. 4a and FIG. 4b show schematic illustration of the joint 30 in a third view and a fourth view, respectively.

The joint 30 has two joint elements 31 which are connected to one another and can be rotated with respect to one another and in each of which a joint holder 32 is formed, which is configured to accommodate a carrier element 20 so that it can be displaced in the longitudinal direction during assembly. For this purpose, the joint holder 32 is configured to accommodate the carrier element 20 in a form-fitting manner in the longitudinal direction. The joint holder 32 has a first and a second groove 33, which are each configured to accommodate one of the wing portions 22 in a form-fitting manner in the longitudinal direction. The joint holder 32 can have a cylinder element 34 which is configured to accommodate the tube portion 21 in a form-fitting manner in the longitudinal direction. The first and the second grooves 33 can be arranged opposite with respect to the joint holder 32.

Each of the two joint elements 31 of the joint 30 has two partial joint elements 31a, 31b, the joining of which forms the joint holder 32 including the first and second grooves 33. The partial joint elements 31a, 31b are non-releasably connected to one another. The joint elements 31 are arranged on a common shaft 35 and can be rotated relative to one another by means of the shaft 35.

Each of the two joint elements 31 has a plurality of locking openings 36 which are arranged such that they intersect the first or the second groove 33. The locking openings 36 are positioned such that they are aligned with the openings 23 of the wing portion 22 of the carrier element 20 upon the accommodation of the carrier element 20 in one of the joint elements 31 and corresponding displacement of the carrier element 20. The positioning of the locking openings 36 is correspondingly adapted to the distances of the openings 23 of the wing portion 22 from one another. Subsequently, the carrier element 20 can be releasably connected to one of the joint elements 31 by means of a locking means 37, for example a screw and nut, through the openings 23 and the locking openings 36. Additionally or alternatively, the carrier element can also be locked by the locking means 37 by pressing the partial joint elements 31a, 31b.

The joint 30 also has a rotational locking means 38 which is configured to releasably lock a relative rotation of the joint elements 31. For this purpose, one of the joint elements 31 has a plurality of rotational locking openings 39, and the other of the joint elements has at least one rotational locking opening 39 which are each configured to align with one another at certain angles of rotation when the joint elements 31 are rotated. The rotational locking means 38 can have, for example, a screw and a nut.

FIG. 5a shows a schematic illustration of a mounting element 50 in a first view, and FIG. 5b shows a schematic illustration of the mounting element 50 in a second view. The mounting element 50 has a mounting holder 51 which is configured to accommodate a carrier element so that it is displaceable in the longitudinal direction during assembly (before locking).

The mounting holder 51 of the mounting element 50 has a third and a fourth groove 52 in order to each accommodate one of the wing portions 22 in a form-fitting manner in the longitudinal direction. The mounting holder 51 has a second cylinder element 53 in order to accommodate the tube portion 20 in a form-fitting manner in the longitudinal direction. The third and the fourth grooves 52 are arranged opposite with respect to the mounting holder 51.

The mounting element 51 can have two partial mounting elements 51a, 51b, the joining of which forms the mounting holder 51 and in particular the third and fourth grooves 52. In this way, the partial mounting elements 51a, 51b are connected to one another (releasably or non-releasably).

The mounting element 51 also has a second locking means 54 in order to releasably lock a longitudinal movement of the carrier element accommodated in the mounting element. The mounting element can have at least one mount locking opening which preferably intersects the third groove or the fourth groove 52. The at least one mount locking opening can be arranged such that it aligns with one of the openings 23 of the wing portion 22 when the carrier element is accommodated.

The second locking means 54 can have at least one second locking fastening means which is configured to releasably lock the carrier element 20 by means of the mount locking opening and the opening 23 in the wing portion 22. The second locking fastening means can have a screw connection or a latching connection. Additionally or alternatively, the carrier element 20 can also be locked by the second locking means 54 by pressing the partial mounting elements 51a, 51b.

The mounting element 50 also has a connection element 55, by means of which, for example, a support element 70 and/or a functional module such as a film production module can be attached. The connection element 55 is tubular and is arranged substantially perpendicular to the longitudinal direction of the mounting holder 52.

FIG. 6 shows a schematic illustration of a first partial arrangement with a joint 30 and two carrier elements 20. One of the two carrier elements 20 is fastened in each of the two joint elements 31. Furthermore, a mounting element 50 is arranged on each of the carrier elements 30.

FIG. 7a shows a schematic illustration of a second partial arrangement with a joint 30, two carrier elements 20 and two mounting elements 50, and FIG. 7b shows a schematic illustration of a third partial arrangement with a joint 30, two carrier elements 20 and a mounting element 50. One or more support elements 70 are fastened to each of the connection elements 55 of each of the mounting elements 50.

FIG. 8 shows a schematic illustration of a support structure 80 in a first view, FIG. 9a shows a schematic illustration of the support structure 80 in a second view, and FIG. 9b shows a schematic illustration of the support structure 80 in a third view.

The support structure 80 has a plurality of carrier elements 20 which are connected to one another by means of a plurality of joints 30. In addition, two mounting elements 50 are fastened to each of the carrier elements 20 in the vicinity of each of the joints 30.

The support structure 80 also has a head element 81 with which a plurality of carrier elements 20 can be connected centrally. The support structure 80 has a plurality of arms 82, each comprising a group of carrier elements 20 (carrier element groups) and joints 30 (joint groups). The carrier elements 20 of each arm 82 are each connected to one another in a row (serially).

Each of the arms 82 is fastened to the head element 81 at a first arm end and is arranged on a base or ground at a second arm end via a foot element 83. The arms 82 are formed and arranged on in such a way that the support structure 80 has a hood shape. For this purpose, each of the arms 82 is formed substantially as a quarter circle.

The head element 81 has a plurality of head connection elements 84, which in the present case extend in a ray-shaped manner from the head element center. The head connection elements 84 are each spaced apart from one another at an equal angle and arranged in a plane. The head element 84 also has a plurality of head fastening means 85 for connecting to one of the carrier elements 82.

FIG. 10a shows a schematic illustration of a further embodiment of the support structure 80 in a first view, FIG. 10b shows a detail view of the support structure 80, FIG. 11a shows a schematic illustration of the support structure 80 in a second view, and FIG. 11b shows a schematic illustration of the support structure 80 in a third view.

In the embodiment shown, adjacent arms 82 are additionally connected to one another via support elements 70, which in turn are fastened to the arms 82 by means of mounting elements 50. For example, a first support element 50a of a first arm 82a and a second mounting element 50b of an adjacent second arm 82b are connected via a first support element 70a. The first support element 70a is fastened to the first mounting element 50a and the second mounting element 50b in particular in a manner that cannot be displaced.

Furthermore, a third mounting element 50c on the first arm 82a, which is adjacent to the first mounting element 50a of the first arm 82a, is connected to a fourth mounting element 50d on the second arm 82b, which is adjacent to the second mounting element 50b of the second arm 82b, via a second support element 70b. The first support element 70a and the second support element 70b are arranged crosswise.

The arms 82 are formed and arranged on in such a way that the support structure 80 has a polygonal prism shape which substantially corresponds to a cylinder. For this purpose, each of the arms 82 is formed substantially in an L shape.

FIGS. 12 to 14 show schematic illustrations of an arrangement in which a support rod 92 is held on the carrier element 20 by means of a further mounting element 90 via a connecting piece 91 integrally formed thereon. Functional modules 94, for example, cameras for picture taking, are releasably arranged on the support rod 92 by means of a respective holder 93.

According to FIG. 12b, the further mounting element 90 is formed with a clamp 95a and a counter clamp 95b on which the integrally formed connection piece 91 is formed. Together, clamp 95a and counter clamp 95b grasp around the carrier element 20 substantially completely grasp around.

FIG. 13b shows a detail B relating to a clampable holder 96 for releasably accommodating the support rod 92 on the integrally formed connection piece 91. In the example shown, the clampable holder 96 is in turn integrally formed on the connecting piece 91. In the region of a portion of the support rod 92 which is arranged in the clampable holder 95, the support rod 92 has a thickened portion 97.

FIG. 14b shows a detail C relating to the holders 93 for releasable (clamping) attachment of the respective functional module 94 to the support rod 92. The holder 93 is designed as a clamping clip that can be releasably clipped onto the support rod 92. For clamping, a screw connection (not shown) can be inserted into openings 98. This can be provided in a comparable manner with the clampable holder 96 according to FIG. 13b.

The features disclosed in the preceding description, the claims and the drawing can be of importance, both individually and in any combination, in realizing the various embodiments of the invention.

1. An arrangement for supportingly accommodating a functional module, comprising:
a modular support structure is formed with carrier elements which are provided with a hollow cross-section and profile elements lying opposite one another, wherein the profile elements each have a middle half-tube portion and partial wing portions integrally formed thereon on both sides with profile element openings, and the partial wing portions of the profile elements are arranged flat on top of one another in such a way that the profile element openings are assigned to one another in pairs, the half-tube portions of each of the carrier elements form a tube portion, and the partial wing portions of each of the carrier elements each form a wing portion, and
a functional module which is mounted on the support structure.

2. The arrangement according to claim 1, wherein the wing portions each extend in the longitudinal direction of the tube portion and are substantially planar.

3. The arrangement according to claim 1, wherein the tube portion has a substantially round or oval cross-section, and the wing portions extend radially from the tube portion.

4. The arrangement according to claim 1, wherein the partial wing portions are each arranged in alignment with one another and are non-releasably connected to one another.

5. The arrangement according to claim 1, wherein the
half-tube portions of each of the profile elements are each arranged in a common plane.

6. The arrangement according to claim 1, wherein the tube portion has a constant tube portion thickness, and the wing portions each have a constant wing portion thickness.

7. The arrangement according to claim 1, wherein the wing portions each have a wing portion width of between 25% and 100% of a tube portion width.

8. The arrangement according to claim 1, wherein the functional module is a functional module from the following group: film production module, image recording module, sound recording module, lighting module and measuring module.

9. The arrangement according to claim 1, further comprising carbon fibers.

10. The arrangement according to claim 1, wherein the support structure has a joint with joint elements which are connected to one another and rotatable with respect to one another, each of which is formed with a joint holder, which is configured to retain a first of the carrier elements therein.

11. The arrangement according to claim 10, wherein the joint has a locking means which is configured to releasably lock a longitudinal movement of the first of the carrier elements.

12. The arrangement according to claim 1, wherein the support structure has a mounting element with a mounting holder in which the first or a second of the carrier elements is arranged, and a connection element with which a support element and/or the functional module is accommodated on the support structure.

13. The arrangement according to claim 1, further comprising a head element which is configured to be releasably connectable to a plurality of the carrier element, wherein:
a first carrier element group and a second carrier element group of the plurality of carrier elements are each connected releasably in series to one another by a first joint group and a second joint group, respectively, of the plurality of joints to form a first arm and a second arm, respectively, and
the first arm and the second arm are each releasably fastened to the head element at a first arm end and are arranged on a base at a second arm end.

14. The arrangement according to claim 13, further comprising a plurality of mounting elements and a first support element, wherein:
a first mounting element of the plurality of mounting elements is fastened to one of the carrier elements of the first arm, and a second mounting element is fastened to one of the carrier elements of the second arm, and
the first mounting element is releasably connected to the second mounting element via the first support element.

15. A modular system for an arrangement for supportingly accommodating a functional module according to claim 1, comprising carrier elements for a modular support structure, wherein the carrier elements are provided with a hollow cross-section and profile elements lying opposite one another, wherein the profile elements each have a central half-tube portion and partial wing portions integrally formed thereon on both sides with profile element openings, and the partial wing portions of the profile elements are arranged flat on top of one another in such a way that the profile element openings are assigned to one another in pairs, the half-tube portions of each of the carrier elements form a tube portion, and the partial wing portions of each of the carrier elements each form a wing portion.
